(19) United States
(12) Patent Application Publication
(10) Pub. No.: US 2009/0134031 A1
(43) Pub. Date: May 28, 2009

(54) Electrophoresis membrane support and manifold unit

(76) Inventor: David Bruce Ogle, New South Wales (AU)

Correspondence Address: COOLEY GODWARD KRONISH LLP;ATTN: Patent Group, Suite 1100, 777 - 6th Street, NW, WASHINGTON, DC, 20001, US

(21) Appl. No.: 10/567,019

(22) PCT Filed: Aug. 4, 2004
(86) PCT No.: PCT/AU04/01032

§ 371 Date: Dec. 30, 2008

(30) Foreign Application Priority Data
Aug. 6, 2003 (AU) 2003904142

(51) Int. Cl. B01D 57/02

(52) U.S. Cl. 204/606; 204/639

(57) ABSTRACT

An electrophoresis membrane support comprising a substantially planar member having four boundaries. an upper face and a lower face; an inlet port disposed near one boundary; an outlet port disposed opposite the inlet port near an opposite boundary; spacers positioned between the inlet port and outlet port adapted to support a membrane positioned on the upper face or on the lower face of the member; interstitial space disposed between the spacers capable of allowing flow of fluid therein; inlet means in fluid communication with the inlet port and the interstitial space; outlet in fluid communication with the interstitial space and the inlet port, the inlet and outlet means adapted to allow flow of fluid along the interstitial space; first flow port disposed near one boundary; and second flow port disposed opposite the first flow port near an opposite boundary, the first and second flow ports direct flow of fluid to or from the electrophoresis apparatus.

### TECHNICAL FIELD

The present invention relates to a membrane support and manifold adapted to accept one or more membranes suitable for use in an electrophoresis apparatus.

### BACKGROUND ART

Membrane-based electrophoresis is a new technology originally developed for the separation of macromolecules such as proteins, nucleotides and complex sugars. This unique preparative electrophoresis technology originally developed for macromolecule separation utilises tangential flow across polyacrylamide membranes with an electric field or potential applied across the membranes. The general design of the system facilitates the purification of proteins and other macromolecules under near native conditions. This results in higher yields and excellent purity. The process provides a high purity, scalable separation that is faster, cheaper and higher yielding than current methods of macromolecule separation. Furthermore, the technology offers the potential to concurrently purify and decontaminate macromolecule solutions.

To scale up any separation technology for commercial applications, new apparatus design and technology are often required. To scale up membrane-based electrophoresis based on the original Gradiflow™ technology developed by Gradipore Limited (see U.S. Pat. No. 6,413,402; U.S. Pat. No. 6,328,869; U.S. Pat. No. 5,393,386; U.S. Pat. No. 5,650,055 and WO 02/24314), the present inventors found it was necessary to significantly alter many of the components of the apparatus to accommodate large membranes and overcome problems encountered with scale-up.

The present inventors have developed an improved membrane support and manifold for use in larger scale membrane-based electrophoresis.

### DISCLOSURE OF INVENTION

In a first aspect, the present invention provides an electrophoresis membrane support comprising:

a substantially planar member having four boundaries, an upper face and a lower face;

an inlet port disposed near one boundary;

an outlet port disposed opposite the inlet port near an opposite boundary;

spacers positioned between the inlet port and outlet port adapted to support a membrane positioned on the upper face or on the lower face of the member;

interstitial space disposed between the spacers capable of allowing flow of fluid therein;

inlet means in fluid communication with the inlet port and the interstitial space;

outlet in fluid communication with the interstitial space and the inlet port, the inlet and outlet means adapted to allow flow of fluid along the interstitial space;

first flow port disposed near one boundary; and

second flow port disposed opposite the first flow port near an opposite boundary, the first and second flow ports direct flow of fluid to or from the electrophoresis apparatus.

Preferably, two electrophoresis membrane supports are adapted to be assembled in an electrophoresis apparatus or cartridge to form transverse fluid flow paths along respective interstitial spaces formed by a support. .

In a preferred form, at least some of the inlet, outlet and flow ports are provided as channels formed in each respective boundary of the member.

In another preferred form, at least some of the inlet, outlet and flow ports are formed as a plurality of ports or holes in the member.

Preferably, the inlet and outlet ports are formed as non-circular ports to assist in movement of fluid in the port to enter the inlet or outlet means.

Preferably, the spacers are formed as a plurality of substantially planar parallel members running from the inlet means to the outlet means.

The inlet means is preferably formed by a series of flow channels directing fluid from the inlet port to the interstitial space.

The outlet means is preferably formed by a series of flow channels directing fluid from the interstitial space to the outlet port.

Preferably, the membrane support is substantially square in shape with the ports disposed near each of the four boundaries forming the square.

In a preferred form, the support further contains one or more drain ports. The drain ports are preferably in communication with drain channels adapted to receive any fluid escaped from the ports or interstitial spaces.

The membrane supports can be stacked between membranes in an electrophoresis apparatus or cartridge to form a plurality of flow paths, one or more flow paths being transverse to an adjacent support.

In a second aspect, the present invention provides an electrophoresis separation unit comprising:

a first manifold having at least one inlet port and one outlet port;

a second manifold having at least one inlet port and one outlet port;

a plurality of electrophoresis membrane supports according to the first aspect of the present invention disposed between the first manifold and the second manifold; and

a plurality of ion-permeable membranes disposed between the membrane supports forming a plurality of adjacent flow chambers between the membranes;

wherein in use the direction of flow of fluid in one flow chamber is transverse to the direction of flow of another flow chamber.

Preferably, the electrophoresis separation unit contains two membrane supports and three membranes forming a first flow chamber and a second flow chamber.

Preferably, the first manifold includes a first inlet port and first outlet port in fluid communication with the first chamber and a second inlet port and second outlet port in communication with the second chamber. The first manifold may further include a third inlet port and third outlet port.

In one preferred form, the second manifold includes a first inlet port and first outlet port in communication with the first chamber and a second inlet port and second outlet port in communication with the second chamber. The second manifold may further include a third inlet port and third outlet port.

The electrophoresis separation unit may contain an electrode associated with both the first and second manifolds.

In a preferred form, the electrophoresis separation unit comprises:

a first manifold having a first inlet port and first outlet port, a second inlet port and second outlet port, and a third inlet port and a third outlet port;

a second manifold having an inlet port and outlet port;

a first ion-permeable membrane disposed adjacent the first manifold;

a second ion-permeable membrane disposed adjacent the first ion-permeable membrane;

a third ion-permeable membrane disposed adjacent the second manifold;

a first membrane support disposed between the first ion-permeable membrane and the second ion-permeable membrane;

a second membrane support disposed between the third ion-permeable membrane and the second ion-permeable membrane;

a first fluid chamber adapted to receive fluid in a first stream disposed between the first ion-permeable membrane and the second ion-permeable membrane;

a second fluid chamber adapted to receive fluid in a second stream between the second ion-permeable membrane and the third ion-permeable membrane;

a first electrolyte chamber containing a first electrode disposed between the first ion-permeable barrier and the first manifold; and

a second electrolyte chamber containing a second electrode disposed between the third ion permeable barrier and the second -manifold;

wherein the first inlet port and first outlet port are in fluid communication with the first fluid chamber, the second inlet port and second outlet port are in fluid communication with the second fluid chamber, the third inlet port and third outlet port are in fluid communication with the first electrolyte chamber, and the inlet port and outlet port are in fluid communication with the second electrolyte chamber, and wherein in use the direction of flow of the first steam is transverse to the direction of flow of the second stream.

Preferably, at least one ion permeable membrane, is a hydrogel membrane. The membranes may have defined pore sizes or pore -size distributions suitable for size-based separations. The membranes may be charged to allow charge-based separations. The membranes may be endo-electro-osmosis membranes capable of controlling the bulk movement of water. Preferably, at least some of the membranes are formed from or contain hydrogel materials. Such membranes are well known to the art.

In one preferred form, at least one ion-permeable membrane has a characteristic average pore size and pore size distribution. In one form, all the ion-permeable membranes are ion-permeable membranes having a characteristic average pore size and pore size distribution. This configuration of the apparatus is suitable for separating compounds on the basis of charge and or size.

The membranes having a characteristic average pore size and pore size distribution preferably comprise polyacrylamide and have a molecular mass cut-off between about 1 kDa to 5000 kDa. It will be appreciated that the molecular mass cut-off can be larger or smaller depending on the applications and membrane compositions.

In another preferred form, at least one membrane is capable of controlling substantial bulk movement of liquid under the influence of an electric field and is an inducible electro-endo-osmotic membrane. The inducible electro-endo-osmotic membrane is preferably a cellulose tri-acetate (CTA) membrane. It will be appreciated that the inducible electro-endo-osmotic membrane can be formed from any other suitable membrane material such as poly(vinyl alcohol) cross-linked with glutaraldehyde (PVAl+glut).

In another preferred form, at least one membrane is an isoelectric membrane having a characteristic pH value. Preferably, the isoelectric membrane has a pH value in a range of about 2 to 12. When two ion-permeable membranes are isoelectric membranes, the membranes can have the same or different characteristic pH values.

In another preferred form, at least two ion-permeable membranes have a characteristic average pore size and pore-size distribution.

The isoelectric membranes are preferably immobiline polyacrylamide membranes. It will be appreciated, however, that other isoelectric membranes would also be suitable for the present invention.

Suitable isoelectric membranes can be produced by copolymerizing acrylamide, N,N′-methylene bisaccrylamide and appropriate acrylamide derivatives of weak electrolytes yielding isoelectric membranes with pH values in the 2 to 12 range, and average pore sizes that either facilitate or substantially prevent trans-membrane transport of components of selected sizes.

The electrophoresis separation unit is preferably adapted to attach to an electrophoresis apparatus containing one or more of electrolyte reservoirs, sample reservoirs, pump, power supply, monitors, plumbing and the like.

In a third aspect, the present invention provides a membrane cartridge adapted to be positioned in an electrophoresis separation unit comprising:

a housing adapted to receive a plurality of ion-permeable membranes and a plurality of membrane supports according to the first aspect of the present invention, the housing containing a membrane support, first inlet and first outlet ports, second inlet and second outlet ports, flow spacers and at least a first flow chamber and a second flow chambers; and

a retaining support adapted to retain the plurality of ion-permeable membranes and the plurality of membrane supports in the housing, the retaining support containing flow spacers;

wherein in use the direction of fluid flow in the first flow chamber is transverse to the direction of fluid flow of the second flow chamber.

In a fourth aspect, the present invention provides use of an electrophoresis membrane support according to the first aspect of the present invention in an electrophoresis apparatus, unit or cartridge.

In an fifth aspect, the present invention provides a process for electrophoretic treatment of a sample comprising:

providing an electrophoresis separation unit according to the present invention in an electrophoresis system;

passing a sample through at least one flow chamber in the unit;

applying an electric potential; and

causing at least one component in the sample to pass through an ion-permeable membrane in the unit to an adjacent flow chamber.

The unit is assembled such that fluid can be passed through the flow chambers over a membrane. When the unit is placed in a membrane-based electrophoresis system, fluid containing one or more compounds to be treated by electrophoresis can be caused to pass through the flow chambers, an electric field is applied to the system, and one or more compounds can pass through one or more membranes into an adjoining flow chamber. The treated fluid and/or one or more compounds can be collected during or after electrophoresis.

The unit is suitable for large scale separations or treatments as large volumes can pass through the defined spaces during electrophoresis.

The present inventors have found that improved electrophoresis separations can be achieved over prior art apparatus or systems where the flow directions in adjacent flow chambers are typically opposing or in the same direction. Furthermore, problems with gas build up, sealing, stacking of multiple membranes, voids in flow are reduced or overcome by the configuration of the electrophoresis unit according to the present invention. Laminar flow of fluids to be treated are improved also increasing separation efficiencies. The separation unit according to the present invention can be used for scale-up electrophoresis systems.

The membrane supports according to the present invention can be stacked by orienteering alternating spacers at 90 degrees on the same plane. Thus only one spacer can be used for an apparatus having a plurality of flow chambers each having a transverse flow path.

For convenience, the flow of fluid in the first flow chamber is termed ‘stream 1’ and the flow of fluid in the second flow chamber is termed ‘stream 2’. It will be appreciated that the naming maybe reversed such that stream 1 is formed in the second flow chamber and stream 2 is formed in the first flow chamber.

Gradiflow™ is a trade mark of Gradipore Limited, Australia for its membrane-based electrophoresis apparatus.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the claimed invention as it existed in Australia prior to development of the present invention.

In order that the present invention may be more clearly understood, preferred forms will be described with reference to the following drawings and examples.

### BRIEF DESCRIPTION OF THE DRAWINGS

FIG. 1 shows basic concept of the present invention having transverse flow of fluid in adjacent chambers formed by three membranes.

FIG. 2 shows slots (or holes) in the membranes and membrane supports to receive fluid via at least one manifold for stream 1 and stream 2 fluid flow.

FIG. 3 shows detail of a membrane support used to separate and support the membranes and direct flow of fluid over the membranes.

FIG. 4 shows detail of the membrane support of FIG. 1 indicating inlet port, inlet means in more detail, flow channels, interstitial spaces and flow port.

FIG. 5 shows detail of a membrane support used to separate and support the membranes and direct flow of liquid over the membranes of FIG. 1 further containing drain ports.

FIG. 6 shows detail of the membrane support of FIG. 3 indicating flow ports, flow channels, spacers, and drain port.

FIG. 7 shows an exploded view of the stacking of five membranes separated by four membrane supports.

FIG. 8 shows membranes and membrane spacers arranged into a membrane cartridge with a housing and retaining support.

FIG. 9 shows an inner view of a preferred manifold.

FIG. 10 shows the electrode in the manifold of FIG. 9.

FIG. 11 shows an exploded view of three membranes and two membrane supports positioned between two manifolds.

FIG. 12 shows an exploded view of three membranes and two membrane supports having drain ports positioned between two manifolds.

FIG. 13 shows an exploded view of an electrophoresis unit containing an a membrane cartridge of FIG. 8 inserted between two manifolds.

FIG. 14 is a cross-sectional view of a separation unit having three membranes forming first and second chambers. The view shows the first inlet port and first outlet port in fluid communication with the first chamber and electrodes in first and second electrolyte chambers.

FIG. 15 is a cross-sectional view of a separation unit having seven stacked membranes forming three first and three second chambers. The stacked membranes allow an increase in the volume of material that can be processed The view shows the first inlet port and first outlet port in fluid communication with the three first chambers and electrodes in first and second electrolyte chambers.

### MODE(S) FOR CARRYING OUT THE INVENTION

Before describing the preferred embodiments in detail, the principal of operation of a membrane-based electrophoresis apparatus will first be described. An electric field or potential applied to ions in solution will cause the ions to move toward one of the electrodes. If the ion has a positive charge, it will move toward the negative electrode (cathode). Conversely, a negatively-charged ion will move toward the positive electrode (anode).

Membrane-based electrophoresis apparatus (Gradiflow™) developed by, or in association with, Gradipore Limited, Australia are suitable for performing the methods described herein and are fully disclosed in commonly assigned U.S. Pat. No. 6,413,402, U.S. Pat. No. 6,328,869, U.S. Pat. No. 5,39386, U.S. Pat. No. 5,650,055 and WO 02/24314. The apparatus may include a cartridge which houses a number of membranes forming at least two chambers, a cathode and an anode in respective electrode chambers connected to a suitable power supply, reservoirs for samples, buffers and electrolytes, pumps for passing samples, buffers and electrolytes, and cooling means to maintain samples, buffers and electrolytes at a required temperature during electrophoresis. The cartridge typically contains at least three substantially planar membranes disposed and spaced relative to each other to form two chambers through which sample or solvent can be passed. A separation membrane is disposed between two outer membranes (termed restriction membranes as their molecular mass cut-offs are usually smaller than the cut-off of the separation membrane). When the cartridge is installed in the apparatus, the restriction membranes are typically located adjacent to an electrode. One example of a cartridge is described in AU 738361.

In the apparatus, ion-permeable barriers that substantially prevent convective mixing between the adjacent chambers of the manifold according to the present invention are placed in an electric field and components of the sample are selectively transported through the ion-permeable barriers. The particular ion-permeable barriers used will vary for different applications and generally have characteristic average pore sizes and pore size distributions and/or isoelectric points allowing or substantially preventing passage of different components.

Having outlined some of the principles of operation of an apparatus, a manifold and separation unit will be described.

FIG. 1 shows a preferred concept of the present invention providing transverse flow of fluid in adjacent chambers formed by three membranes. The change in flow configuration, although difficult to develop and engineer, results in significant improvement in electrophoresis separation. A transverse flow allows more efficient flow of material over the membranes, reduced void volumes, less gas build-up, and increased separation efficiency. A new membrane support to direct and control liquid flow had to be developed that would allow this new configuration of the electrophoresis separation unit. It will be appreciated, however, that the membrane support can be used alone in an electrophoresis apparatus to support a membrane and provide flow of fluid over the membrane in a controlled and efficient manner.

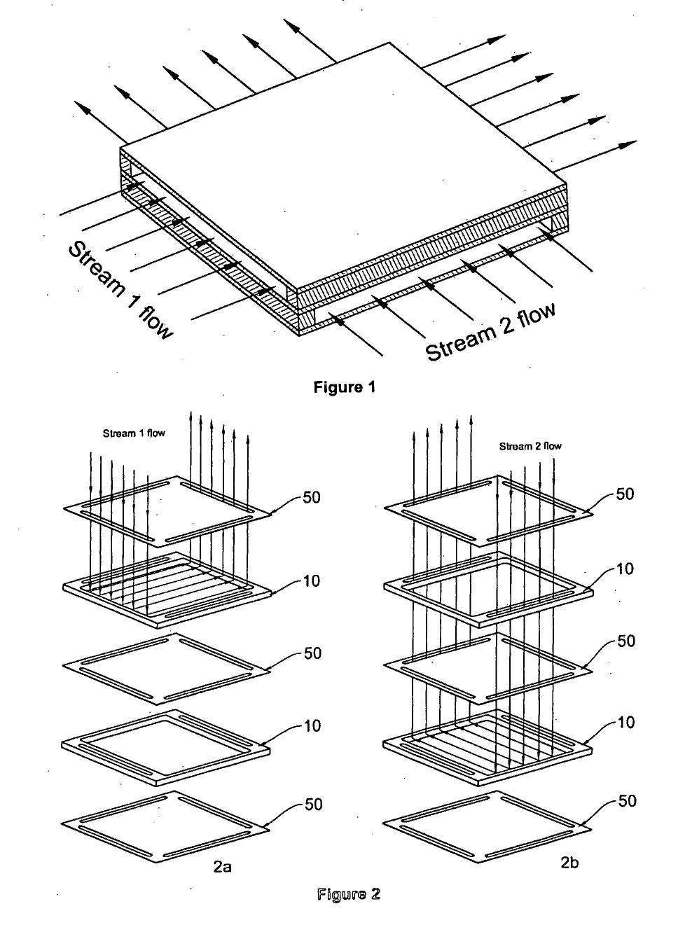

FIG. 2 shows slots (or holes) in the membranes and membrane supports to receive fluid via at least one manifold for stream 1 and stream 2 fluid flow in a unit having three membranes. These slots or holes are called flow ports which allow liquid to pass through the unit from the manifold for each chamber (or stream). FIG. 2a shows stream 1 flow whereas FIG. 2b shows stream 2 flow in a transverse direction.

It is possible to stack the components (five membranes and four membrane supports, for example) to form multiple stream 1 and stream 2 fluid flows between membranes. Such configuration allows improved scale-up of electrophoresis processing. It is also possible to have four separate fluid flows with two manifolds from the top (stream 1 and stream 2) and two manifolds from the bottom (stream 3 and stream 4). A membrane without the manifold slot (holes) is used to separate the two halves in this form.

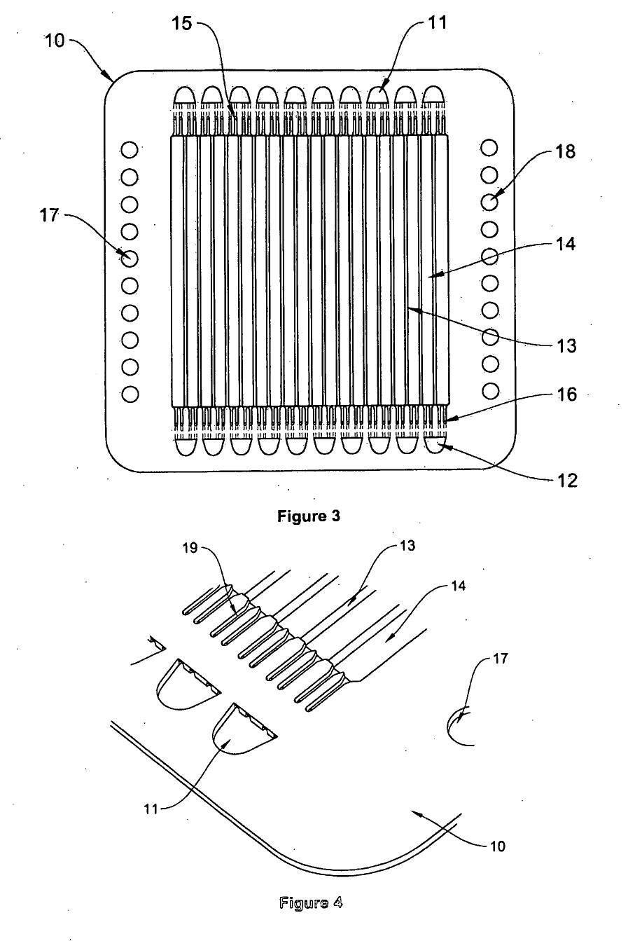

FIG. 3 shows detail of a preferred membrane support 10 used to separate and support a membrane and direct flow of liquid over the membrane. As shown, the membrane support 10 has a substantially square active area. The active area has spacers 13 to minimize contact with the membrane so as not to significantly reduce the effective active area of the membrane. The spacers 13 assist in the following roles:

maintain the spacing between the membranes at preferably about 1 mm. The area between the spacers 13 form an interstitial space 14 and as shown is about 5 mm, which provides adequate membrane support. It will be appreciated that the distance between the spacers 13 can be designed or set to provide support for the membrane. The interstitial space 14 is where fluid flows along the membranes sandwiched between two membrane spacers;

assist in uniform flow distribution across the active area of the membrane. The spacers 13 prevent side-to-side flow of liquid resulting in regions of low velocity. In one preferred form, the ends of the spacers 13 are flared to assist even flow into and out of the interstitial space 14 and to prevent “dead zones”. Areas of static flow or regions that do not drain well are commonly referred to as “dead zones”.

added structural support for the membrane.

The inlet to and outlet from the interstitial space 14 is preferably in the form of flow channels 19, consisting of the inlet flow channels 15 and the outlet flow channels 16, respectively and have two preferred main roles:

provide even flow to the interstitial space 14 by creating a pressure drop between inlet flow ports 11 and the outlet flow ports 12. The dimensions of the flow channels 19 can control the flow rate in each flow chamber. The flow channels 19 preferably do not have any sharp edges or corners to maintain even flow distribution and to prevent “dead zones”. The entry into the chamber is preferably flared, also to assist flow distribution and the prevention of “dead zones”.

provide a seal between the membrane supports 10 and the flow chambers. Each flow channel 19 consists of two sections with an under and an over section. The bottom of each flow channel 19 forms an arch to maintain strength to withstand the sealing forces.

The flow ports 17, 18 for the other stream, preferably consist of a series of round holes. Round holes have the following advantages:

no corners to minimize low flow regions or “dead zones”.

tooling for cutting the membranes is relatively simple as off-the-shelf punches are incorporated into the cutting knife.

no flat edges which can allow the membrane to fold over and block the channel region.

FIG. 4 shows an closer view of a preferred form of an inlet means 15 (or outlet means 16) for the support 10 of FIG. 3. The inlet port 11 contains flow channels 19 positioned at one end of the port running to the interstitial space 14 to direct flow of fluid to the membrane and chamber.

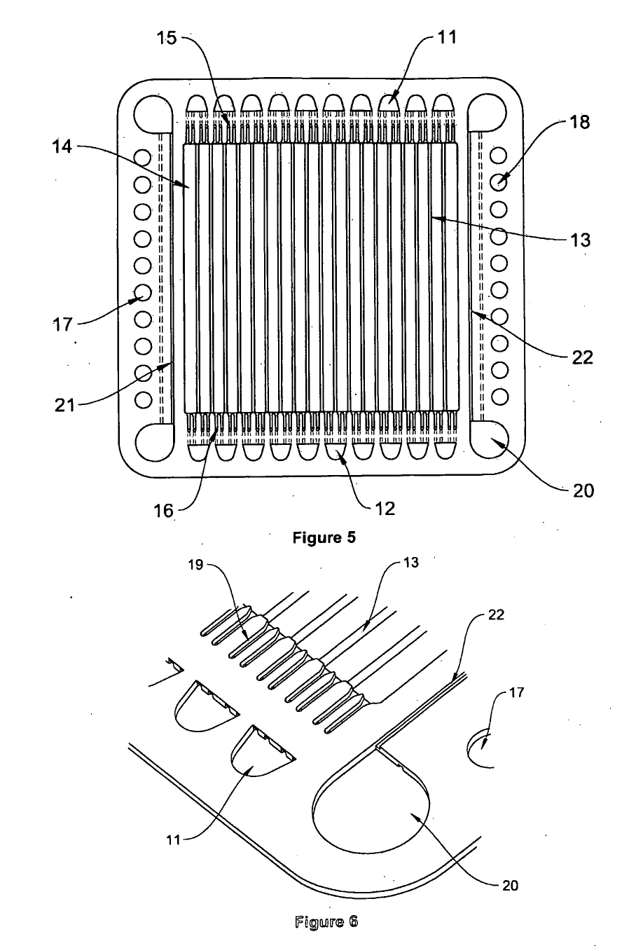

In one preferred form as set out in FIG. 5 and FIG. 6 the membrane support 10 incorporates a drain system containing drain ports 20 disposed at each corner of the support 10 to prevent stream 1 in the first flow chamber leaking into stream 2 of the second flow chamber and vice versa. Drain channels 21, 22 run along the seal between the two flow chambers. If a leak occurs from a flow chamber towards the flow ports 11, 12, 17, 18 of the other flow chamber (or vice versa), the liquid will encounter a drain channel 21 or 22. The leak will be diverted along the drain channel 21, 22 to one of four holes 20 in the corners of the support 10. The streams in the flow chambers can be slightly pressurized due to the flow and therefore liquid cannot flow from the drain channels 21, 22 back into the flow chambers. The drain 20 prevents a leak via the seals between the flow chambers. Corresponding drain holes 20 are also cut in the membranes 50 to allow any fluid material that may have leaked from a chamber to drain from the apparatus.

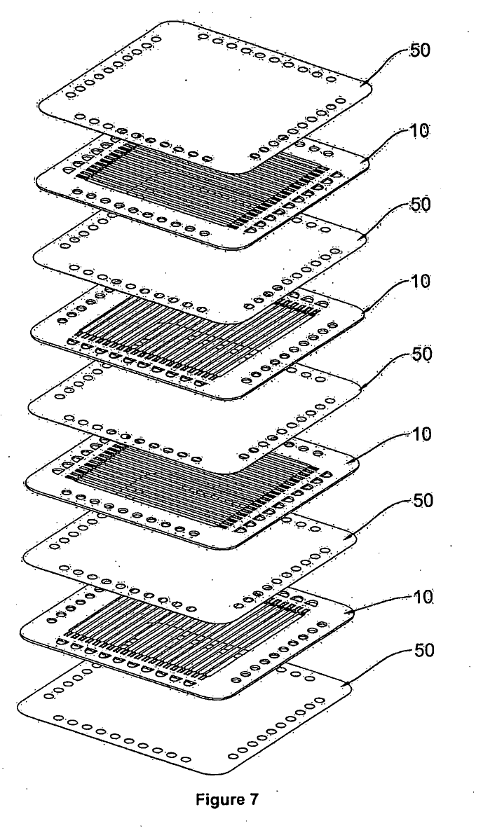

FIG. 7 shows an exploded view of the stacking of five membranes 50 separated by four membrane supports 10. As can be seen, each support 10 is positioned at 90 degrees from the adjacent support 10 to provide tangential flow in adjacent chambers.

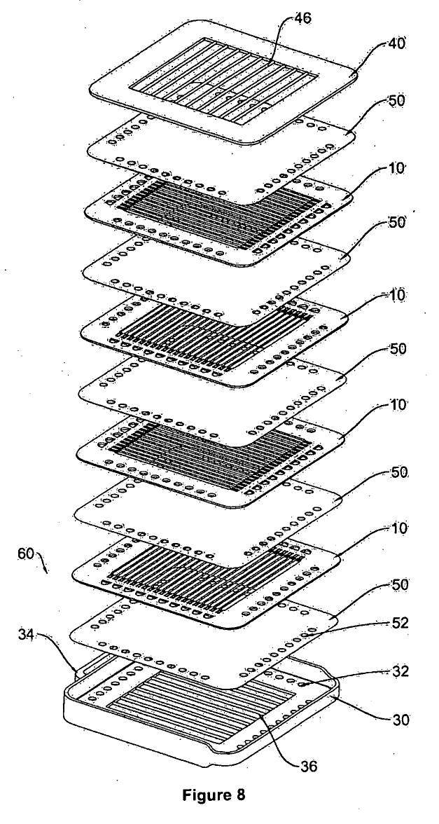

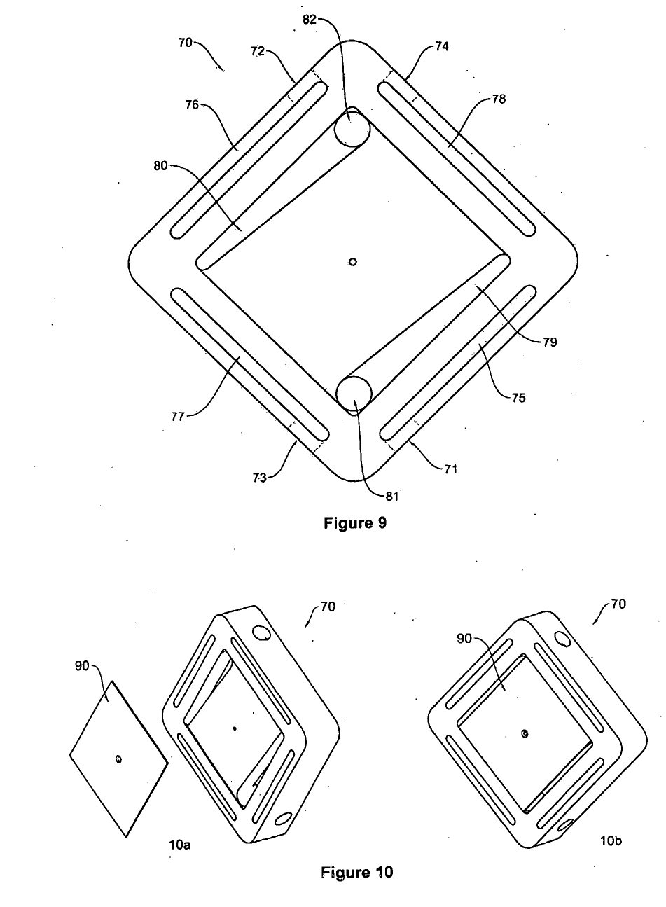

FIG. 8 shows membranes 50 and membrane supports 10 arranged into a membrane cartridge 60 with a housing 30 and a retaining support 40. Fluid enters from the bottom via the holes 32 in the housing 30. The cartridge 60 contains a housing 30 that holds all the components such as membranes 50 and supports 10. The housing 30 has a handle 34 and slides over the manifolds of a separation unit during insertion.

In a preferred form, the housing 30 has parallel spacers 36 with the following design roles:

maintain the spacing between the membranes 50 and electrodes at about 2 mm.

assist in uniform electrolyte or buffer flow distribution across the electrode. The spacers prevent side-side flow of buffer resulting in regions of low velocity.

holds the membranes 50 in place during transport and handling of the cartridge 60.

added structural support for the cartridge 60.

The membranes 50 are typically square with circular holes for the flow ports 52. Tooling for cutting the membranes is relatively simple as off-the-shelf punches are incorporated into the cutting knife. Optionally, four holes in the membranes are included for connection of the drain channels to the separation unit.

The retaining support 40 has similar parallel spacers 46 as the housing 30 as well as lugs for locating and locking into the housing 30. The retaining support 40 is simply pushed down onto the membrane/support pack and the shape of the locking lugs secure the retaining support in place. Single layers or multiple stacks can be placed in the cartridge 60.

FIG. 9 shows an inner view of a first manifold 70. The manifold 70 is preferably made from a pharmaceutical grade plastic such PVDF. In one form, the second manifold 80 is similar to the first manifold 70 but does not have the inlet 71, 73 and outlet ports 72, 74 and channels 75 for providing fluid to the first and second chambers. In another form, the second manifold 80 is the same as the first manifold 70 allowing up to four streams in four chambers in the separation unit.

The manifold 70 is preferably oriented so that the inlets 71, 73 are lower than the outlets 72, 74 forming a diamond configuration. This configuration allows all chambers to drain completely to the bottom point minimizing the any hold-up volumes. Similarly, air and gases rise to the top point and are removed with the liquid flow. There are preferably no sharp corners or edges on any channels to ensure smooth flow, minimize “dead zones” and meet draining requirements.

The first chamber and second chamber are substantially symmetrical and each inlet 71, 73 and outlet 72, 74 consist of a circular port and a tapered distribution channel of rectangular cross section. The port size is matched to the remainder of the electrophoresis apparatus in which the unit is to be inserted. The distribution channels 75, 76, 77, 78 preferably have tapered depths, deepest near the port with the full liquid flow and shallow at the ends where the liquid flow is much less. The tapered channel maintains constant flow velocity and constant Reynolds number as some of the flow is diverted into the stream manifold. This assists with even distribution of the stream flow, from the ports into the stream manifold 70. Pressures are balanced because each path though the grid requires one pass though a distribution channel. The flow along the bottom edge does not pass through the inlet distribution channel but passes through the entire length of the outlet distribution channel. Similarly flow along the top edge passes through the entire inlet distribution channel but does not pass though the outlet distribution channel. Flow through the middle passes through half the inlet distribution channel and half the outlet distribution channel. The buffer flow path also has circular ports 81, 82 and tapered distribution channels 79, 80 of rectangular cross section. The taper is along the width rather than the depth. The tapered distribution channels have the same design roles as the streams. The electrode 90, as shown in FIG. 10, sits over the buffer distribution channels with a gap along two edges. This forces the buffer to flow over the edge of the electrode 90 and evenly over the surface of the electrode 90. The electrode 90 is preferably a flat plate of platinum coated titanium or other suitable conductive material.

One or more gaskets can be added to the manifolds to improve sealing between membranes, supports or manifolds.

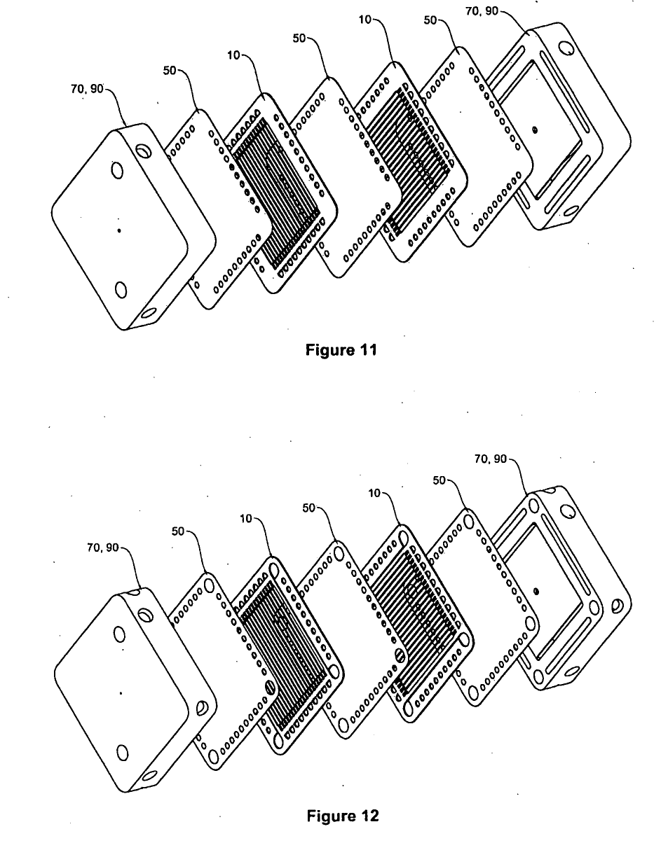

FIG. 11 shows an exploded view of manifold 80 with three membranes 50 and two membrane supports 10. This configuration provides two flow chambers.

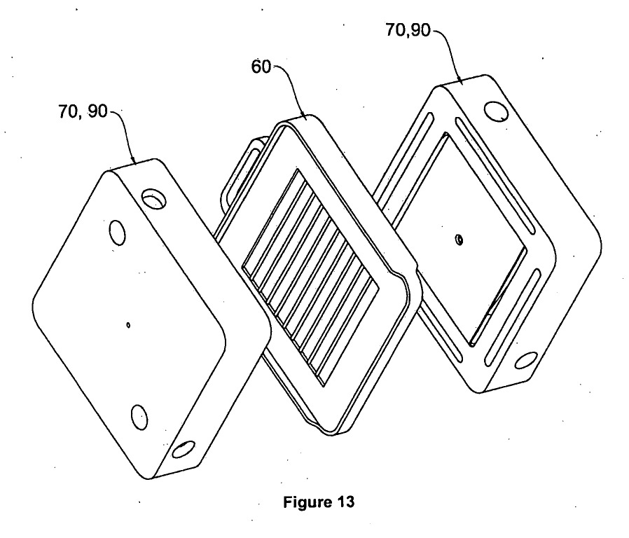

FIG. 12 shows an exploded view of manifold 80 with three membranes 50 and two membrane supports 10. This configuration provides two flow chambers together with drain ports as shown in FIG. 5 and FIG. 6.

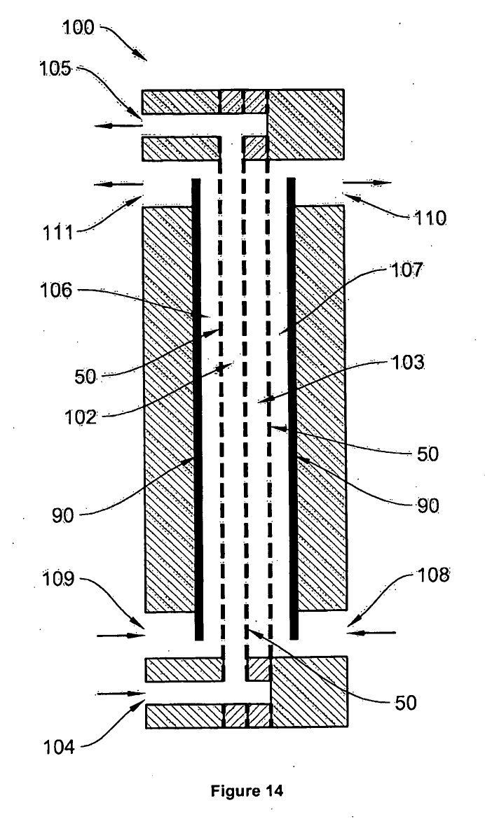

FIG. 13 shows an exploded view of two manifolds with the membranes and membrane supports housed in a removable cartridge of FIG. 8.

FIG. 14 a cross-sectional view of a separation unit having three membranes 50 forming a first flow chamber 102 and second flow chamber 103. The view shows the first inlet port 104 and first outlet port 105 in fluid communication with the first chamber 102 and electrodes 90 in first electrolyte chamber 106 and second electrolyte chamber 107. Electrolyte inlets 108,109 allow flow of electrolyte into the electrolyte chambers 106, 107, Electrolyte outlets 110, 111 allow flow of electrolyte out of the electrolyte chambers 106, 107.

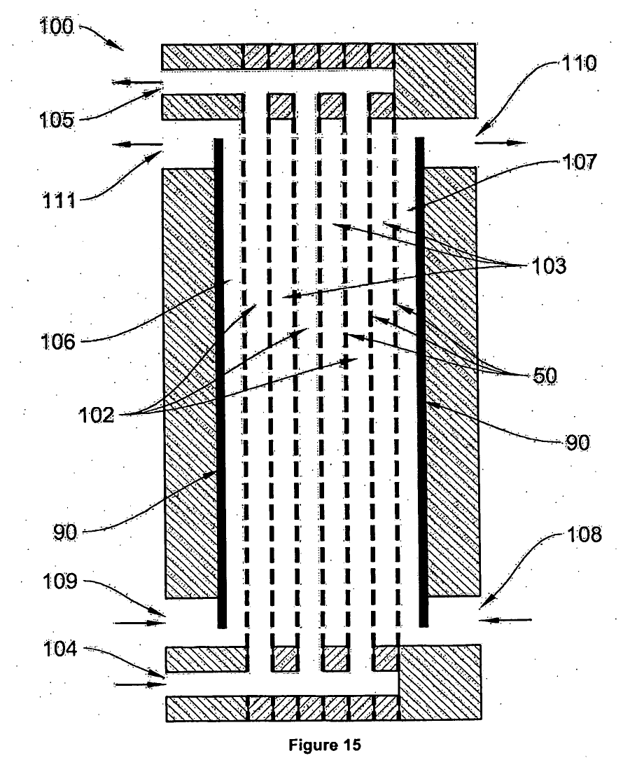

FIG. 15 a cross-sectional view of a separation unit having seven stacked membranes 50 forming three first flow chambers 102 and three second flow chambers 103. The stacked membranes 50 allow an increase in the volume of material that can be processed. The view shows the first inlet port 104 and first outlet port 105 in fluid communication with the three first flow chambers 102 and electrodes 90 in first and second electrolyte chambers 106, 107.

In use, the separation unit is attached to an electrophoresis apparatus containing one or more pumps which act as means to provide sample or solution to the first and/or second chambers via the respective inlet and outlet ports. Electrolyte, in the form of water, salt solution or buffer, is added to the first and second electrolyte chambers each containing an electrode. An electric potential is applied between the two electrodes and one or compounds in the sample are caused to move through at least one membrane to effect an electrophoretic separation. As sample, solution, buffer and electrolyte can be passed through chambers in the unit in streams, this allows faster separation or treatment by electrophoresis. The movement also allows the possibility for cooling and removal of gas build-up.

In a preferred form, the membrane support 10 is substantially square in shape having dimensions of about 31 cm×31 cm. The support 10 contains 25 inlet ports 11, 25 outlet ports 12 located on opposite boundaries. Each inlet port 11 and out let port 12 has four flow channels 19 forming the inlet means 16 and outlet means 17, respectively. There is one flow spacer 13 forming two interstitial spaces 14 between each inlet port 11 and outlet port 12. Thus there are 50 interstitial spaces 14 formed by 25 flow spacers 13. On opposing boundaries are 25 first flow ports 17, and 25 second flow ports 18. In use, the supports can be assembled between membranes but rotated 90 degrees to each other to form transverse flow paths to improve electrophoresis separation. The support can also contain one or more drain ports. Preferably, the drain ports are position near each corner of support in communication with drain channels adapted to receive fluid escaped from the ports or interstitial spaces.

The cartridge or unit adapted to receive the membrane supports and the membranes can be designed to be self draining. The cartridge or unit can be formed to be disposable or can be disassembled to add new membranes and for cleaning. It will be appreciated that the cartridges can be designed to be stacked to provide many separation streams.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. An electrophoresis membrane support comprising:
a substantially planar member having four boundaries, an upper face and a lower face;
an inlet port disposed near one boundary;
an outlet port disposed opposite the inlet port near an opposite boundary;
spacers positioned between the inlet port and outlet port adapted to support a membrane positioned on the upper face or on the lower face of the member;
interstitial space disposed between the spacers capable of allowing flow of fluid therein;
inlet means in fluid communication with the inlet port and the interstitial space;
outlet in fluid communication with the interstitial space and the inlet port, the inlet and outlet means adapted to allow flow of fluid along the interstitial space;
first flow port disposed near one boundary; and
second flow port disposed opposite the first flow port near an opposite boundary, the first and second flow ports direct flow of fluid to or from the electrophoresis apparatus.

2. The support according to claim 1 wherein two supports are adapted to be assembled in an electrophoresis apparatus or cartridge to form transverse fluid flow paths along respective interstitial spaces formed by each support.

3. The support according to claim 1 or 2 wherein at least some of the inlet, outlet and flow ports are provided as channels formed in each respective boundary of the member.

4. The support according to claim 1 or 2 wherein at least some of the inlet, outlet and flow ports are formed as a plurality of ports or holes in the member.

5. The support according to claim 1 or 2 wherein the inlet and outlet ports are formed as non-circular ports to assist in movement of fluid in the port to enter the inlet or outlet means.

6. The support according to any one of claims 1 to 5 wherein the spacers are formed as a plurality of substantially planar parallel members running from the inlet means to the outlet means.

7. The support according to any one of claims 1 to 6 wherein the inlet means is formed by a series of flow channels directing fluid from the inlet port to the interstitial space.

8. The support according to any one of claims 1 to 7 wherein the outlet means is formed by a series of flow channels directing fluid from the interstitial space to the outlet port.

9. The support according to any one of claims 1 to 8 being substantially square in shape with the ports disposed near each of the four boundaries forming the square.

10. The support according to any one of claims 1 to 9 further comprising one or more drain ports.

11. The support according to claim 10 wherein the drain ports are in communication with drain channels adapted to receive fluid escaped from the ports or interstitial spaces.

12. An electrophoresis separation unit comprising:
a first manifold having at least one inlet port and one outlet port;
a second manifold having at least one inlet port and one outlet port;
a plurality of electrophoresis membrane supports according to any one of claims 1 to 11 disposed between the first manifold and the second manifold; and
a plurality of ion-permeable membranes disposed between the membrane supports forming a plurality of adjacent flow chambers between the membranes;
wherein in use the direction of flow of fluid in one flow chamber is transverse to the direction of flow of another flow chamber.

13. The separation unit according to claim 12 having two membrane supports and three membranes forming a first flow chamber and a second flow chamber.

14. The separation unit according to claim 13 wherein the first manifold includes a first inlet port and first outlet port in fluid communication with the first chamber and a second inlet port and second outlet port in communication with the second chamber.

15. The separation unit according to any one of claim 13 wherein the second manifold includes a first inlet port and first outlet port in communication with the first chamber and a second inlet port and second outlet port in communication with the second chamber.

16. The separation unit according to any one of claims 12 to 15 further containing an electrode associated with both the first and second manifolds.

17. The separation unit according to claim 12 comprising:
a first manifold having a first inlet port and first outlet port, a second inlet port and second outlet port, and a third inlet port and a third outlet port;
a second manifold having an inlet port and outlet port;
a first ion-permeable membrane disposed adjacent the first manifold;
a second ion-permeable membrane disposed adjacent the first ion-permeable membrane;
a third ion-permeable membrane disposed adjacent the second manifold;
a first membrane support disposed between the first ion-permeable membrane and the second ion-permeable membrane;
a second membrane support disposed between the third ion-permeable membrane and the second ion-permeable membrane;
a first fluid chamber adapted to receive fluid in a first stream disposed between the first ion-permeable membrane and the second ion-permeable membrane;
a second fluid chamber adapted to receive fluid in a second stream between the second ion-permeable membrane and the third ion-permeable membrane;
a first electrolyte chamber containing a first electrode disposed between the first ion-permeable barrier and the first manifold; and
a second electrolyte chamber containing a second electrode disposed between. the third ion permeable barrier and the second manifold;
wherein the first inlet port and first outlet port are in fluid communication with the first fluid chamber, the second inlet port and second outlet port are in fluid communication with the second fluid chamber, the third inlet port and third outlet port are in fluid communication with the first electrolyte chamber, and the inlet port and outlet port are in fluid communication with the second electrolyte chamber, and
wherein in use the direction of flow of the first steam is transverse to the direction of flow of the second stream.

18. The separation unit according to any one of claims 12 to 17 wherein at least one ion permeable membrane is a hydrogel membrane, an endo-electro-osmosis membranes capable of controlling the bulk movement of water, an isoelectric membrane, or a membrane having defined pore size or pore size distribution.

19. A membrane cartridge adapted to be positioned in an electrophoresis separation unit comprising:
a housing adapted to receive a plurality of ion-permeable membranes and a plurality of membrane supports according to any one of claims 1 to 11, the housing containing a membrane support, first inlet and first outlet ports, second inlet and second outlet ports, flow spacers and at least a first flow chamber and a second flow chambers; and
a retaining support adapted to retain the plurality of ion-permeable membranes and the plurality of membrane supports in the housing, the retaining support containing flow spacers;
wherein in use the direction of fluid flow in the first flow chamber is transverse to the direction of fluid flow of the second flow chamber.

20. Use of an electrophoresis membrane support according to any one of claims 1 to 11 in an electrophoresis apparatus, unit or cartridge.

21. A process for electrophoretic treatment of a sample comprising:
providing an electrophoresis separation unit according to any one of claims 12 to 18 in an electrophoresis system;
passing a sample through at least one flow chamber in the unit;
applying an electric potential; and
causing at least one component in the sample to pass through an ion-permeable membrane in the unit to an adjacent flow chamber.
